(19) United States
(12) Patent Application Publication
(10) Pub. No.: US 2009/0223125 A1
(43) Pub. Date: Sep. 10, 2009

(54) POT WITH STEAM-RECOVERING SELF-IRRIGATION AND PROCESS FOR USING SUCH POT

(76) Inventor: Michele Piccolo, Torino (IT)

Correspondence Address: SHELDON MAK ROSE & ANDERSON PC, 100 Corson Street, Third Floor, PASADENA, CA, 91103-3842, US

(21) Appl. No.: 11/721,027

(22) PCT Filed: Oct. 19, 2005
(86) PCT No.: PCT/IT05/00608

§ 371 Date: Jun. 6, 2007

(30) Foreign Application Priority Data
Dec. 23, 2004 (IT) TO2004A000900

(51) Int. Cl. A01G 27/00; A01G 27/04

(52) U.S. Cl. 47/66.7; 47/79; 47/81

(57) ABSTRACT

A pot (1) with steam-recovering self-irrigation is disclosed, comprising at least one vessel adapted to contain mould or another organic substance for an implant of at least one plant, at least one cover equipped with at least one opening for making this plant go out therefrom, the cover defining at least one descending slanted surface arranged above the mould. A process for using a pot (1) with steam-recovering self-irrigation is further disclosed.

The present invention refers to a pot with steam-recovering self-irrigation. The present invention further refers to a process for using a pot with steam-recovering self-irrigation.

The art proposes a great number of systems adapted to allow dispensing liquids for irrigation, particularly water or fertilizing liquids, to vegetable cultures. In particular, the so-called sub-irrigation systems are known, which provide water to plants from below, typically by exploiting the capillary effect generated by one or more ducts connecting a lower interspace obtained in the pots or in the ground containing the plants, and operating as water reserve, with the ground itself. Many of these known systems are also suitable for use as self-irrigation systems, therefore able to guarantee a water supply to plants for prolonged periods, thereby requiring the filling of the water reserve only at relatively long time intervals.

It is obvious that such arrangements, in addition to extend in time the plant irrigation operation, above all in case of home plants for which such operations are typically uncomfortable and cumbersome, allow ensuring long autonomy periods to plant themselves, resulting surely interesting for plants placed in difficult accessible positions, in offices or during long vacation periods.

The known arrangements however generate the self-irrigation effect only by capillary effect, neglecting what is the steam generated by the water reserve, which in such a way is dispersed, generating an efficiency reduction for such arrangements.

Therefore, object of the present invention is providing a pot which allows the self-irrigation effect of plants contained therein by recovering suitable steams generated by the water reserve with which it is equipped and resulting more efficient than known systems.

Another object of the present invention is providing a pot in which the self-irrigation effect through recovering of steams is used together with the self-irrigation due to capillary effect.

A further object of the present invention is providing a process for using a pot with steam-recovering self-irrigation as the one of the present invention.

The above and other objects and advantages of the invention, as will appear from the following description, are reached by a pot with steam-recovering self-irrigation as disclosed in claim 1.

Moreover, the above and other objects and advantages of the invention are reached with a process for using a pot with steam-recovering self-irrigation as disclosed in claim 17. Preferred embodiments and non-trivial variations of the present invention are the subject matter of the dependent claims.

The present invention will be better described by some preferred embodiments thereof, provided as a non-limiting example, with reference to the enclosed drawings, in which:

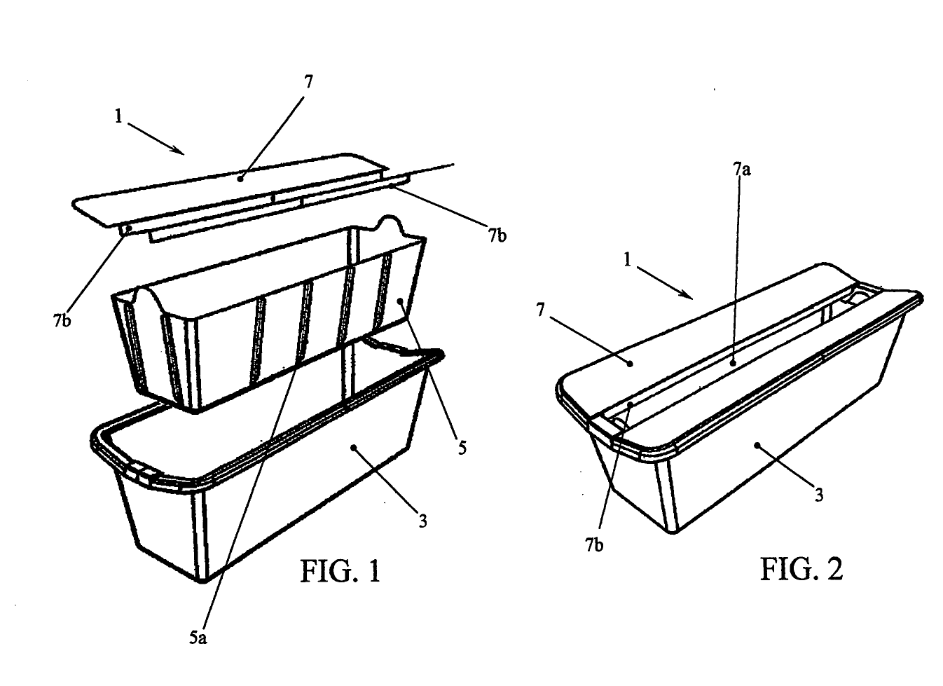

FIG. 1 shows an exploded perspective view of a preferred embodiments of the pot with steam-recovering self-irrigation according to the present invention;

FIG. 2 shows a perspective view of the pot of FIG. 1 as assembled;

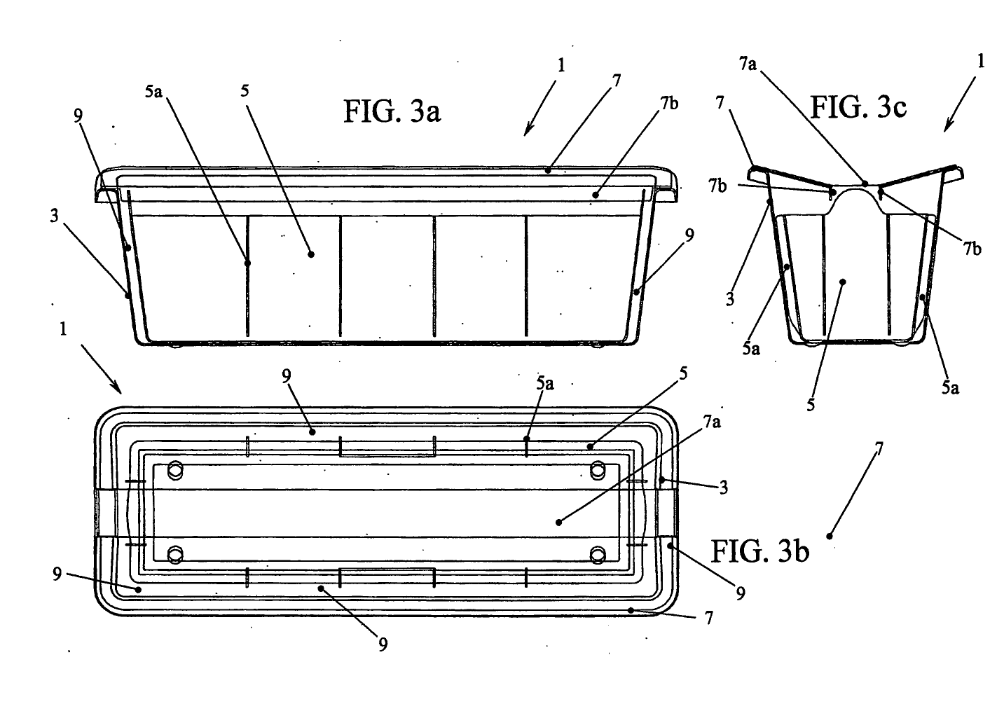

FIG. 3a shows a side sectional view of the pot of FIG. 2;

FIG. 3b shows a front sectional view of the pot of FIG. 2;

FIG. 3c shows a top sectional view of the pot of FIG. 2; and

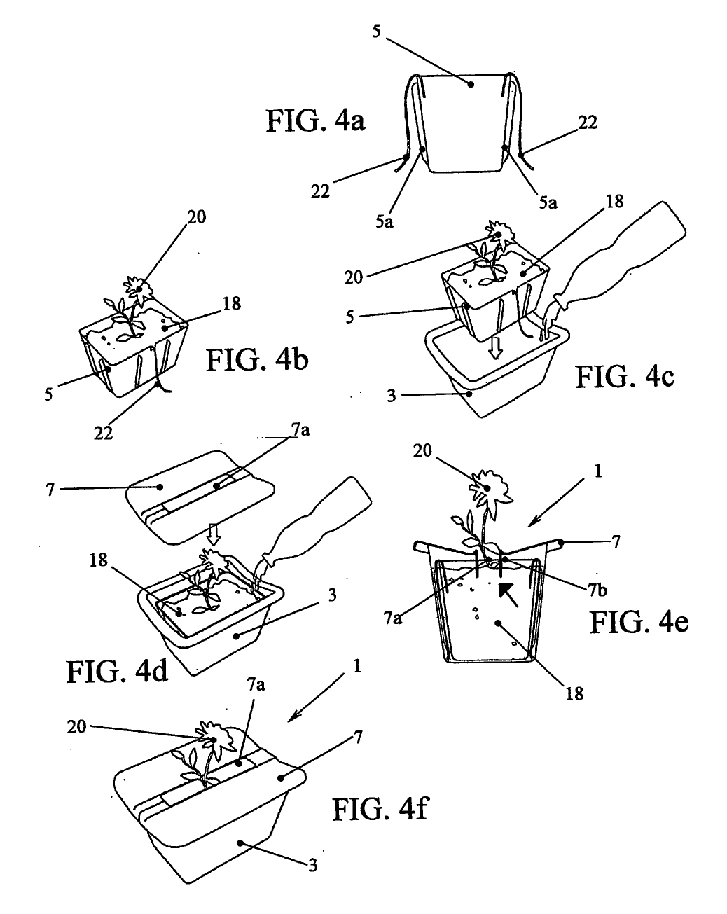

FIG. 4a to 4e show some steps of the use process according to the present invention.

A preferred embodiment, not shown, of the pot with steam-recovering self-irrigation according to the present invention comprises a vessel adapted to contain mould or another organic substance for implanting at least one plant and at least one cover equipped with at least one opening for making the plant project therefrom, such cover defining at least one slanted descending surface arranged above the mould. In this way, it is possible to generate a plant self-irrigation which recovers steams generated by natural evaporation from an irrigation fluid supplied to the mould, for example through traditional watering, and not used by the plant for its feeding, which by rising, instead of being dispersed into the atmosphere, condensate on the cover itself; the condensate then slides by gravity along the slanted cover surface to be taken and discharged in the mould, allowing re-circulation and recover of irrigation fluid and greatly extending the period of time passing between a watering and the following one.

With reference now in particular to FIG. 1 to 3c, it is possible to note another preferred embodiment of the pot with steam-recovering self-irrigation according to the present invention; in such embodiment, the pot 1 according to the present invention comprises an external vessel 3 made of watertight material, at least one internal vessel 5 adapted to be inserted inside the external vessel 3 and at least one cover 7 complying with the previous embodiment. It is clear that, though the pot 1 is shown as an example in the Figures with a substantially parallelepiped shape, it can be in practice made in any other shape or size without departing from the scope of the present invention.

The external vessel 3 is adapted to contain a reserve of irrigation liquid, typically water or a fertilizing liquid and as such can be realised with any watertight material, such as for example plastics or pottery.

It is also clear that, though in the Figures, a pot 1 according to the present invention is shown equipped with a single internal vessel 5, pots 1 can be realised with a greater number of internal vessels 5 inserted inside a same external vessel 3, without therefore departing from the scope of the present invention.

The internal vessel 5 is adapted to be inserted inside the vessel 3 in such a way as to define with this latter one at least one interspace 9: preferably, the interspace 9 should be arranged in a lateral and substantially vertical position, between the external surface of the internal vessel 5 and the internal surface of the external vessel 3, inside which the irrigation liquid is arranged. It is clear that, though the interspace 9 is shown in the Figures as arranged around the internal vessel 5, the vessels 3 and 5 could be shaped and mutually arranged in such a way that the interspace 9 is arranged in a different position, for example only along one side of the internal vessel 5.

In order to guarantee a more stable cooperation between the two vessels 3 and 5, the internal vessel 5 can be equipped, on its external surface, with a plurality of wings or ribs 5a adapted to abut against the internal surface of the external vessel 3, more dimensionally accurately defining the interspace 9. It is useful to note that the vessels 3 and 5 are shaped in such a way that, when the internal vessel 5 is inserted inside the external vessel 3, the interspace 9 has no upper cover or other constraints which could prevent the natural ascent of steams generated by evaporation of the irrigation fluid contained therein.

The internal vessel 5 is further adapted to contain mould 18, or other organic substance, inside which it is possible to implant at least one plant 20.

The cover 7, adapted to be inserted above the external vessel 3, like in the previously described embodiment, is equipped with at least one opening 7a through which the seeding part of the plant 20 is made project, and is shaped in such a way that, when in position, it is covering at least part of the interspace 9 and at least part of the internal vessel 5 containing the mould 18, and defines at least one slanted descending surface from a portion thereof arranged above the interspace 9 towards a portion thereof arranged above the part of the internal vessel 5 containing the mould 18. In this way, it is possible to generate self-irrigation of the plant 20 by recovering steams generated due to natural evaporation from the irrigation fluid contained in the interspace 9 which, when rising, condensate on the portion of the cover 7 arranged above the interspace 9; the condensate then slides by gravity along the slanted surface of the cover 7 to be taken and discharged in the mould 18. In order to favour such condensate re-circulation, the end of the slanted surface portion arranged above the internal vessel 5 part containing the mould 18 can be equipped with at least one, substantially vertical wing 7b adapted to connect the mould 18 to the slanted surface of the cover 7.

It is therefore clear that the pot 1 according to the present invention allows the constant and prolonged humidification of the mould 18 by recovering the evaporation of the irrigation fluid contained in the interspace 9, making it condense on the slanted surface of the cover 7 and generating its fall inside the mould 18 itself, greatly extending the necessary watering times of the plant 20. Moreover, due to the use of steams or condensate as self-irrigation means, the use of the pot 1 according to the present invention allows greatly reducing the amount of chlorine residuals transferred to plants from normal drinking waters used for traditional irrigation or watering.

Though in the Figures, the cover 7 is shown as a single cover 7 having one or more slanted surfaces, depending on position and number of interspaces 9 of the pot 1, and one or more openings 7a, it is quite clear that it can be realised differently, such as for example composed of two half-covers, each one equipped with a slanted surface descending from the external vessel 3 periphery towards the internal vessel 5 portion containing the mould 18, and defining together the opening 7a due to two offsets with which they are respectively equipped, always however remaining within the scope of the present invention as previously described. It is further clear that, in order to make the cooperation between cover 7 and external vessel 3 tighter, the cover 7 itself can be equipped with at least securing clip (not shown) cooperating with an edge of the external vessel 3 in a known way.

Moreover, it can be provided to equip the internal vessel 5 with at least one hole (not shown) adapted to take back the irrigation fluid contained in the mould 18 and not used by the plant 20 for its feeding, in the irrigation fluid reserve contained in the interspace 9, in such a way as to further extend the operating cycles of the pot 1.

Moreover, in order to increase the efficiency of the pot 1 according to the present invention, it is possible to provide for the use of capillary conduction means of the irrigation fluid, such as for example a wick 22, which connect the irrigation fluid reserve contained in the interspace 9 with the mould 18 inside the internal vessel 5.

In an alternative embodiment, not shown, of the pot according to the present invention, it is possible to provide that the internal vessel is sized so that, once inserted inside the external vessel, it defines the interspace only in the space included between the bottoms of the two vessels. In this way, the plant self-irrigation is guaranteed by capillary conduction means of the irrigation fluid and by the cover which recovers the condensate only from the mould, as previously described for the first embodiment of the pot according to the present invention.

The present invention further refers to a process for using a pot with steam-recovering self-irrigation according to the present invention. With reference to FIGS. 4a to 4f, it is possible to note that the process according to the present invention comprises the steps of:

arranging the mould 18 and the plant 20 inside the vessel or the internal vessel 5 (FIG. 4b); in case of the embodiment of pot 1 shown in the Figures, such step can be preceded by the step of arranging the capillary conducting means 22 in such a way that they connect the internal vessel 5 interior with the outside and afterwards with the irrigation fluid reserve contained in the interspace 9 (FIG. 4a);

watering the mould 18 (FIG. 4d); in case of the embodiment of pot 1 shown in the Figures, such step can be preceded by the steps of pouring the irrigation liquid inside the external vessel 3 (FIG. 4c) and inserting the internal vessel 5 into the external vessel 3 (FIG. 4d); in such step, the irrigation liquid is arranged on the interspace 9;

placing the cover 7 on the vessel or on the external vessel 3 in such a way that, preferably, the wings 7b are in contact with the mould 18 (FIG. 4e) and that the plant 20 goes out of the opening 7a.

The efficiency of the pot 1 and its process of use according to the present invention has been proven also by tests performed by external institutions. In particular, on May 13, 2005, before the Department of Vegetal Biology of the University of Turin (Italy), three exotic plants have been placed into three pots 1 according to the present invention (such plants were, in particular, Spatiphyllum wallisii Regel, Dracaena sanderiana Hort. Sand and Cordiline terminalis Kunth), in order to check whether the pot 1 operation for keeping an adequate degree of humidity in the mould without periodic watering is efficient and allows keeping the plants in good conditions for prolonged periods. The three pots 1 have then been filled with a suitable mould for the affected species, enough water has been delivered for guaranteeing the right substrate humidity and the interspace in the various pots 1 has been filled with water. The pots 1 have then been taken in a temperature-stabilised greenhouse in full light and the plant status has been periodically checked. At the end of the test, whose length had been established in two months, it has been checked that the general plant status was satisfactory, that new leaves have been grown and that the mould has a degree of humidity similar to the starting one, though no water topping-up had been performed. Consequently, the Department of Vegetal Biology of the University of Turin has verified that the use of the pots 1 according to the present invention has allowed guaranteeing for the tested species a suitable water supply for the plants, without a need of periodic watering interventions, guaranteeing a constant microhabitat and reducing possible stress situations for a period of at least two months (that can be prolonged till five/six months depending on atmospheric conditions) with respect to current watering intervals of traditional pots which are of about three/four days.

Moreover, the use of the pot 1 according to the present invention allows obtaining numerous other advantages, such as, for example, removal of stagnant water, proliferation of mosquitoes, and obtaining a distribution of fertilizers possibly dissolved in the irrigation liquid or arranged in the mould 18.

1. A pot with steam-recovering self-irrigation comprising at least one vessel adapted to contain mold or another organic substance for an implant of at least one plant, wherein the pot comprises at least one cover equipped with at least one opening for making said plant go out therefrom, said cover defining at least one descending slanted surface arranged above said mold.

2. The pot according to claim 1, wherein the pot comprises an external vessel, at least one internal vessel adapted to be inserted inside said external vessel and at least one of said cover equipped with at least one opening for making said plant go out therefrom, said external vessel being adapted to contain a reserve of irrigation liquid, said internal vessel inserted in said external vessel defining at least one interspace containing said irrigation liquid and said internal vessel being adapted to contain mold or another organic substance for an implant of at least one plant.

3. The pot according to claim 2, wherein said external vessel is made of watertight material.

4. The pot according to claim 2, wherein said interspace is lateral and is arranged between an external surface of said internal vessel and an internal surface of said external vessel.

5. The pot according to claim 2, wherein said interspace is arranged between a bottom of said internal vessel and a bottom of said external vessel.

6. The pot according to claim 2 and 4, wherein said cover is covering at least one part of said interspace and at least one part of said internal vessel containing said mold and defines at least one slanted surface descending from a portion thereof arranged above said interspace towards a portion thereof arranged above said part of said internal vessel containing said mold.

7. The pot according to claim 2, wherein said irrigation liquid is water or a fertilizing liquid.

8. The pot according to claim 2, wherein said external surface of said internal vessel comprises a plurality of wings or ribs abutting onto said internal surface of said external vessel.

9. The pot according to claim 2, wherein an end of said portion of said slanted surface arranged above said part of said internal vessel containing said mold is equipped with at least one vertical wing (7b) adapted to contain said mold with said slanted surface of said cover.

10. The pot according to claim 1, wherein said cover comprises two half-covers.

11. The pot according to claim 10, wherein each one of said half-covers comprises a slanted surface descending from a periphery of said external vessel towards a portion of internal vessel containing said mold.

12. The pot according to claim 10, wherein each one of said half-covers comprises at least one offset defining said opening.

13. The pot according to claim 2, wherein said internal vessel comprises at least one hole adapted to take back said irrigation liquid contained in said mold, and not used by said plant, into said reserve of said irrigation liquid contained in said interspace.

14. The pot according to claim 13, wherein the pot further comprises capillary conducting means of said irrigation liquid connecting said reserve of said irrigation liquid contained in said interspace to said mold inside said internal vessel.

15. The pot according to claim 14, wherein said capillary conducting means comprises at least one wick.

16. The pot according to claim 1 or 2, wherein said cover comprises at least one securing clip cooperating with an edge of said vessel or said external vessel.

17. A process for using a pot with steam-recovering self-irrigation according to claim 2, wherein the process comprises the steps of:
a) arranging said mold and said plant inside said vessel or said internal vessel;
b) watering said mold; and
c) placing said cover onto said vessel or onto said external vessel.

18. The process according to claim 17,
wherein said interspace is lateral and is arranged between an external surface of said internal vessel and an internal surface of said external vessel;
wherein said external surface of said internal vessel comprises a plurality of wings or ribs abutting onto said internal surface of said external vessel; and
wherein the process further comprises the steps of:
a) pouring said irrigation liquid inside said external vessel;
b) inserting said internal vessel into said external vessel; and
c) placing said cover onto said external vessel with said wings (7b) in contact with said mold and with said plant going out of said opening.

19. The process according to claim 18, wherein said internal vessel comprises at least one hole adapted to take back said irrigation liquid contained in said mold, and not used by said plant, into said reserve of said irrigation liquid contained in said interspace;
wherein the pot further comprises capillary conducting means of said irrigation liquid connecting said reserve of said irrigation liquid contained in said interspace to said mold inside said internal vessel; and
wherein the process further comprises the step of arranging said capillary conducting means for connecting the interior of said internal vessel with said reserve of said irrigation liquid contained in said interspace.
